(19) United States
(12) Patent Application Publication
(10) Pub. No.: US 2011/0019227 A1
(43) Pub. Date: Jan. 27, 2011

(54) DATA PROCESSING SYSTEM, DATA PROCESSING PROGRAM AND PRINTING DEVICE

(75) Inventors: Wataru MIZUMUKAI, Nagoya-shi (JP); Takashi OHMIYA, Nagoya-shi (JP); Keitaro TOMONO, Nagoya-shi (JP)

Correspondence Address: Scully, Scott, Murphy & Presser, P.C., 400 Garden City Plaza, Suite 300, Garden City, NY, 11530, US

(73) Assignee: BROTHER KOGYO KABUSHIKI KAISHA, Aichi-ken (JP)

(21) Appl. No.: 12/817,720

(22) Filed: Jun. 17, 2010

(30) Foreign Application Priority Data
Jul. 23, 2009 (JP) 2009-172474

(51) Int. Cl. G06F 3/12

(52) U.S. Cl. 358/1.15

(57) ABSTRACT

There is provided a data processing system including a display device, a printing device, a generation unit and a writing unit. The display device is provided with a display function, and the printing device is provided with a printing function. The generation unit is configured to generate display data from print data, the display data being displayable on the display device, and the print data being printable by the printing device. The writing unit is configured to write the display data and the print data in the display device, the printing device printing the print data stored in the display device.

### CROSS REFERENCE TO RELATED APPLICATION

This application claims priority from Japanese Patent Application No. 2009-172474 filed Jul. 23, 2009. The entire content of the priority application is incorporated herein by reference.

### TECHNICAL FIELD

The present invention relates to a data processing system including a display device and a printing device, and also to a program for writing data in the display device. The present invention further relates to a printing device that is provided with at least one of a function for writing data on the display device and a function for printing the data written on the display device.

### BACKGROUND

Recently, a Personal Digital Assistant (PDA) and an electronic paper have been developed as a portable display device. Further, a digital photo frame has also become commercially available. Such a digital photo frame stores image data taken by a digital camera or the like, and automatically displays the image data.

There has also been proposed a data processing system in which a display device and a printing device are communicably connected to each other and data is exchanged therebetween. For example, Laid-open Japanese Patent Application Publication No. 2008-225551 discloses a data processing system that includes a data processing device, a printing device and an electronic paper. In this data processing system, the data processing device first transmits a print job to the printing device for output. Upon receipt of the print job, the printing device coverts the print job into display data that is displayable on the electronic paper, and transmits the display data to the electronic paper. In this way, the display data for being displayed on the electronic paper is transmitted to the electronic paper from the data processing device via the printing device.

### SUMMARY

In the above data processing system, when the display data written in the electronic paper is asked for being printed, print data needs to be generated from the display data. However, since the display data is originally generated for the display device, there may arise a difference in quality between the display data and the print data (print job) that was initially transmitted to the printing device. Therefore, the display data stored on the display device may possibly be less appropriate for printing than the print data.

For example, suppose that the display device is a low-resolution device capable of displaying in black and white only, whilst the printing device is a high-resolution device capable of printing in colors. In this case, even if the data processing device outputs print data of a high resolution to the printing device, the printing device needs to convert the print data into display data adapted for the display device and then transmits the display data to the display device. As a result, the display data converted from the print data becomes monochromic and has a low-resolution. Printing such low-resolution display data adapted for the black-and-white display device inevitably results in a printed material of low quality, even though the original print data transmitted from the data processing device is in color and has a high-resolution.

In view of the foregoing, it is an object of the present invention to provide a data processing system, a data processing program and a printing device that allow data stored in a display device to be printed in a manner suitable for printing.

In order to attain the above and other objects, there is provided a data processing system including a display device, a printing device, a generation unit and a writing unit. The display device is provided with a display function and the printing device is provided with a printing function. The generation unit is configured to generate display data from print data, the display data being displayable on the display device, and the print data being printable by the printing device. The writing unit is configured to write the display data and the print data in the display device, the printing device printing the print data stored in the display device.

According to another aspect of the present invention, there is provided a non-transitory storage medium that stores a set of program instructions executable on a computer. The set of program instructions includes: generating display data from print data, the display data being displayable on a display device connectable to the computer, the print data and the display data being in association with each other; and writing the display data and the print data in the display device.

According to still another aspect of the present invention, there is provided a printing device including a printing unit, a print data acquisition unit, a display data generation unit, and a writing unit. The printing unit is configured to print print data, and the print data acquisition unit is configured to acquire the print data. The display data generation unit is configured to generate display data from the print data, the display data being displayable on a display device connectable to the printing device. The writing unit is configured to write the display data and the print data in the display device.

According to further aspect of the present invention, there is provided a printing device including a printing unit, a communication unit, an instruction unit and a replacing unit. The printing unit is configured to print print data. The communication unit is configured to allow data communications with a display device capable of storing the print data and display data displayable on the display device, the print data and the display data being in association with each other. The instruction unit is configured to instruct any one of the print data and the display data stored in the display device to be printed. The replacing unit is configured to replace the display data with the print data associated with the display data when the instruction unit instructs the display data to be printed.

### BRIEF DESCRIPTION OF THE DRAWINGS

In the drawings:

FIG. 1 is a block diagram illustrating a configuration of a printing system common to first to fifth embodiments of the present invention, the printing system including a printer, an electronic paper and a personal computer;

FIG. 2 is a block diagram conceptually illustrating an electronic configuration of the printer;

FIG. 3 is a flowchart showing procedures of a print job reception process according to the first embodiment;

FIG. 4 is a view showing an example of data structure stored in the electronic paper according to the first embodiment;

FIG. 5 is a flowchart showing procedures of an electronic paper printing process according to the first embodiment;

FIG. 6 is a view showing an example of a print target selection screen according to the first embodiment;

FIG. 7 is a view showing another example of the print target selection screen according to the first embodiment

FIG. 8 is a flowchart showing procedures of a print job reception process according to the second embodiment;

FIG. 9 is a flowchart showing procedures of a print job reception process according to the third embodiment;

FIG. 10 is a conceptual view of an example of integrated images in which display data and additional image are combined together according to the third embodiment;

FIG. 11 is a flowchart showing procedures of a print job reception process according to the fourth embodiment of the present invention; and

FIG. 12 is a flowchart showing procedures of a print job reception process according to the fifth embodiment of the present invention.

### DETAILED DESCRIPTION

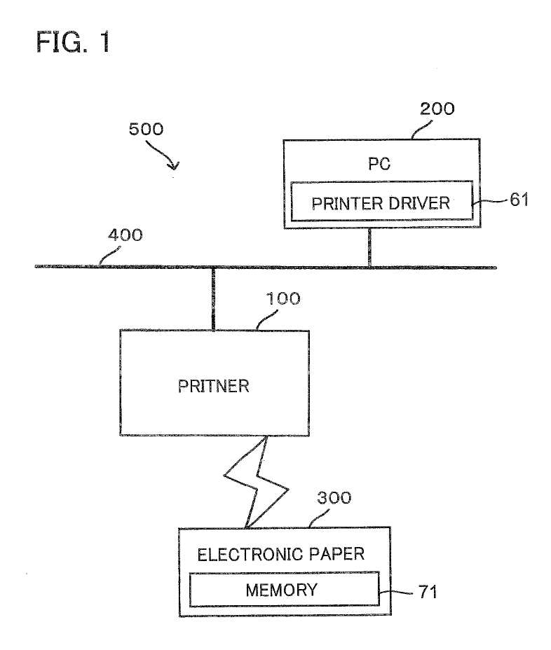

First, a general configuration of a data processing system 500 that is common to first through fifth embodiments of the present invention will be described with reference to FIG. 1.

As shown in FIG. 1, the data processing system 500 is configured of a printer 100 (printing device), an electronic paper 300 (display device) and a PC 200 (data processing device). The printer 100 and the PC 200 are connected with each other via a network 400.

The PC 200 is embedded with a printer driver 61 for controlling operations of the printer 100. When a user designates a print job on the PC 200, the PC 200 transmits the print job to the printer 100 via the printer driver 61. Upon receipt of the print job, the printer 100 outputs (prints) the print job.

The electronic paper 300 has an internal memory 71 for storing data and is provided with a wireless communication function. The printer 100 is also provided with a wireless communication function, as will be described later. Therefore, whenever the electronic paper 300 is located within a communicable range of the printer 100, the printer 100 can write and print data in the internal memory 71 of the electronic paper 300.

The configuration of the data processing system 500 is not limited to the above-described configuration. For example, the data processing system 500 may include a plurality of printers, PCs and electronic papers. Other data processing device and printing device may also be connected to the network 400.

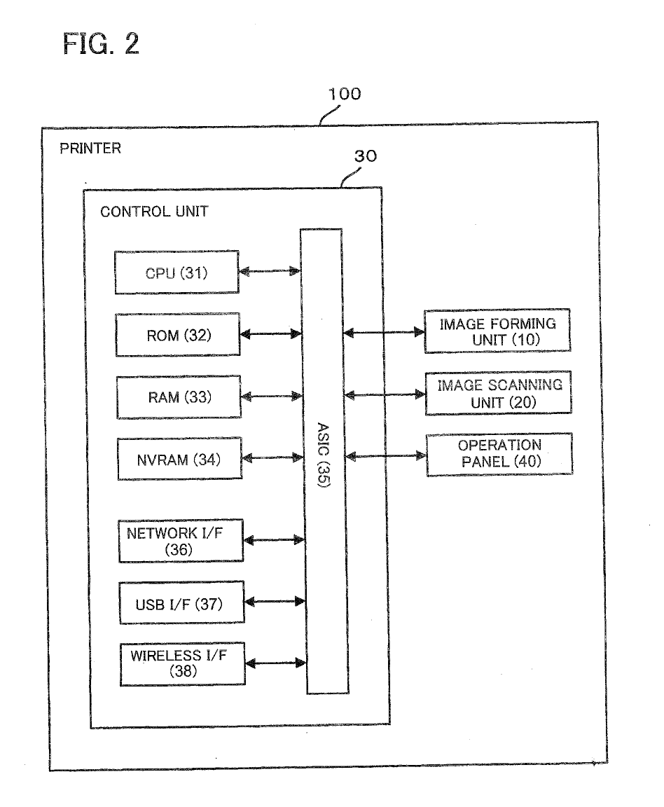

A general configuration of the printer 100 will be described next with reference to FIG. 2. The printer 100 includes a control unit 30, an image forming unit 10, an image scanning unit 20 and an operation panel 40, as shown in FIG. 2. The control unit 30 is electrically connected to the image forming unit 10, the image scanning unit 20 and the operation panel 40 respectively.

The image forming unit 10 forms images on sheets of paper using a well-known method, such as an electrophotographic system and an inkjet system. The image scanning unit 20 scans images placed on a platen. The operation panel 40 includes a liquid crystal display section and a plurality of buttons (such as a start key, a stop key and numerical keys). The operation panel 40 displays operational states of the printer 100, and a user of the printer 100 can input operations on the operation panel 40.

The control unit 30 includes a CPU 31, a ROM 32, a RAM 33, an NVRAM 34, an ASIC 35, a network interface 36, an USB interface 37 and a wireless communication interface 38.

The ROM 32 stores various programs for controlling the printer 100, settings and initial values or the like. The RAM 33 provides a work area for the various programs and temporarily stores image data.

The CPU 31 controls each element of the printer 100 via the ASIC 35 in accordance with the programs in the ROM 32 and signals transmitted from various sensors, while storing results of computation in the RAM 33 and the NVRAM 34.

The network interface 36 is connected to the network 400 so as to allow communications with the PC 200 on which the printer driver 61 for the printer 100 is installed. The USB interface 37 provides connections to an external device having an USB terminal. The wireless communication interface 38 enables wireless access to an external device provided with a wireless communication function (the electronic paper 300 in the present embodiment). In this way, the printer 100 can exchange data with external devices via the network interface 36, the USB interface 37 and the wireless communication interface 38.

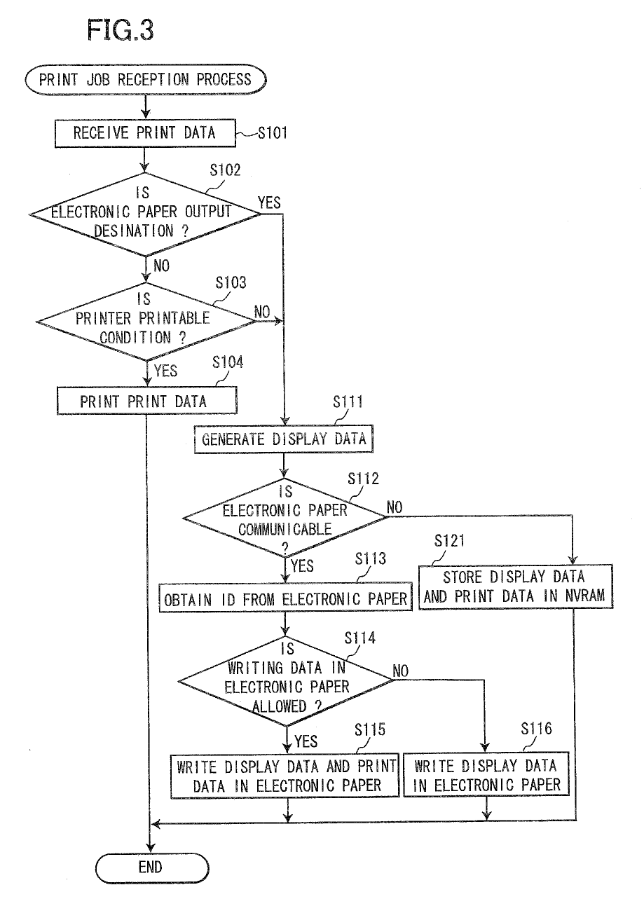

Next, operations of the printer 100 according to a first embodiment will be described with reference to FIGS. 3 through 7.

Specifically, the printer 100 of the first embodiment obtains print data by one of the following ways: by scanning at the image scanning unit 20; by receiving from an external device such as the PC 200; or by directly accessing to an external device connected to the printer 100 (for example, the electronic paper 300 and a USB memory). Of these, explanations will be given to a process of obtaining data by receiving from the PC 200 (a print job reception process) and another process of obtaining data directly from the electronic paper 300 (an electronic paper printing process).

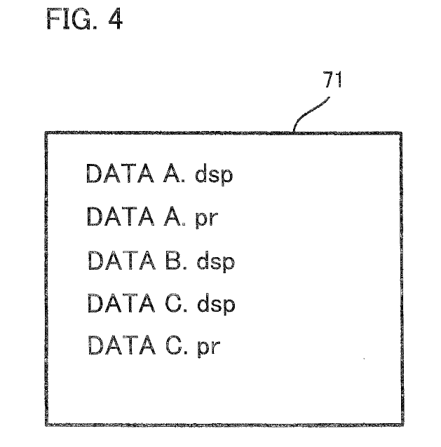

First, the print job reception process according to the first embodiment will be described with reference to a flowchart of FIG. 3 and FIG. 4. Through the print job reception process according to the first embodiment, the printer 100 receives print data (print job) from the PC 200 and prints the print data. This print job reception process starts upon receipt of a print job from the PC 200.

In S101 at the beginning of the print job reception process, the CPU 31 obtains print data (image data in this example) transmitted from the PC 200, such as PDL data (data just before being printed by a printer). The image data obtained from the PC 200 is generated as printable data adapted for the specification of the printer 100.

The print job includes, in addition to the image data, information on various print settings, such as types of sheets, destinations of output and quality of printing.

In S102 the CPU 31 determines whether the print data is directed to the electronic paper 300 for output based on the output destination information contained in the print job. The PC 200 according to the present embodiment can designate the electronic paper 300 as a destination of output, in addition to sheet feeding units provided in the printer 100.

If the electronic paper 300 is not designated as the destination of output, i.e., the print job indicates printing on sheets (S102: NO), the CPU 31 determines whether the printer 100 is in a state that printing can be performed. The printer 100 is deemed impossible to perform printing in case of errors, such as when sheets are run out, and when insufficient toner is left. Also, the printer 100 may be restricted from carrying out printing whenever lack of charge occurs under some kind of charging system, or may be deemed impossible to perform printing when another print job is in progress.

If the printer 100 is in the printable condition (S103: YES), in S104 the CPU 31 controls the image forming unit 10 to print the print data on sheets and subsequently ends the print job reception process.

On the other hand, if the electronic paper 300 is the output destination (S102: YES), or if the printer 100 is not in the printable condition (S103: NO), in S111 the CPU 31 generates display data for the electronic paper 300. In other words, the CPU 31 generates display data that can be displayed on the electronic paper 300 from the print data received from the PC 200.

The display data for the electronic paper 300 is generated as images compatible with display specifications of the electronic paper 300. That is, the print data is converted into the display data corresponding to the display performance (display capability) of the electronic paper 300. In the present embodiment, the display data is generated to satisfy at least one of the following display capabilities of the electronic paper 300: display resolution, displayable colors and volume of data.

Subsequently in S112, the CPU 31 determines whether the printer 100 is communicable with the electronic paper 300. For example, the printer 100 may transmit a signal requesting communications to the electronic paper 300 via the wireless communication interface 38. The printer 100 may determine whether communications with the electronic paper 300 is possible based on whether a reply signal is transmitted from the electronic paper 300 in response to the communication request signal. Alternatively, if the printer 100 receives the reply signal from the electronic paper 300 but the reply signal indicates that the communication is impossible, communications with the electronic paper 300 is deemed impossible.

When the printer 100 is communicable with the electronic paper 300 (S112: YES), the CPU 31 accesses the electronic paper 300 and obtains an ID no. that is peculiar to the electronic paper 300 in S113. Specifically, the electronic paper 300 has prestored the ID issued exclusively therefor (a product serial number, for example). In response to the request of the printer 100, the electronic paper 300 transmits the ID to the printer 100.

In S114 the CPU 31 determines whether the electronic paper 300 is allowed for the print data to be written therein. Specifically, in the first embodiment, the printer 100 prestores a table that stores IDs of electronic papers for which writing print data is allowed. The CPU 31 refers to this table for the ID of the electronic paper 300 obtained in S113. This table may list IDs of electronic papers for which writing print data is allowed, or IDs of electronic papers for which writing print data is not allowed. This table is not necessarily stored in the printer 100, but may be stored in a printer server connected to the printer 100.

The CPU 31 determines whether the print data is allowed to be written in the electronic paper 300 based on whether the ID of the electronic paper 300 is listed in the table.

When determining that writing print data in the electronic paper 300 is allowed (S114: YES), in S115 the CPU 31 writes the display data generated in S111 as well as the print data corresponding to the display data (i.e., the print data from which the display data is generated) in the electronic paper 300. On the other hand, if writing print data in the electronic paper 300 is not allowed (S1114: NO), in S116 the CPU 31 writes the display data only in the electronic paper 300.

When the display data and the print data are written in the electronic paper 300, both data are stored and therefore coexist in the internal memory 71 of the electronic paper 300, as shown in FIG. 4. In FIG. 4, an extension ‘dsp’ represents display data, while an extension ‘pr’ represents print data. Two kinds of data whose names excluding the extensions are identical to each other are derived from the same image, meaning that both data (dsp file and pr file) are in association with each other.

In FIG. 4, ‘data B’ has display data only (data B.dsp) in the internal memory 71 of the electronic paper 300. This is because the ‘data B.dsp’ is written in the electronic paper 300 by a printer from which writing the print data corresponding to this display data in the electronic paper 300 is not permitted. In this way, whether to have print data along with display data is selectively set for each electronic paper 300, thereby specifying (limiting) the electronic paper 300 that can store the print data. This configuration leads to improvement of security. For example, when a plurality of users has the electronic paper 300 individually, restriction on printing can be determined selectively depending on every user. In other words, a user who is not authorized to perform printing cannot write print data in his display device, and therefore cannot print data displayed on this display device. In this way, the present configuration can place restrictions on at least printing print data.

When the printer 100 is determined not to be able to communicate with the electronic paper 300 (S112: NO), in S121 the CPU 31 stores the display data and the print data in the NVRAM 34 of the printer 100. In other words, if writing data in the electronic paper 300 has failed, the CPU 31 saves the unwritten data in the printer 100 in order to prevent the data from being lost. Storing the unwritten data in the printer 100 is also effective in resuming and completing the unfinished writing operation when communications with the electronic paper 300 is restored, since there is no need to obtain the same print data as that obtained in S101 again from the PC 200. Further, since the necessary data has been stored in the printer 100, the data can be printed at an appropriate timing for the user.

The CPU 31 ends the print job reception process after completing writing data in the electronic paper 300 in S115 or S116, or after the data has been stored in the printer 100 in S121.

According to the above-described print job reception process of the first embodiment, upon receipt of a specific print job, the print data and the display data generated from the print data are written in the electronic paper 300 for which writing print data has been permitted. Given that the electronic paper 300 is provided with the print data and the display data, the electronic paper 300 can use the display data for display but use the print data for printing. In other words, even when the display data being shown on the electronic paper 300 is to be printed, the print data corresponding to the display data is used for printing. In this way, printed materials resulting from print data (data suitable for printing) can be obtained.

Suppose that the electronic paper 300 has a low display specification. In this case, the display data would have an image quality lower than that of original print data. Printing such display data may inevitably result in lower-resolution, fewer numbers of colors and reduction of data volume. However, the printer 100 of the present embodiment can output printed materials of high quality, since the printed materials are obtained from the print data of high quality that is suitable for printing.

Further, the printer 100 writes the print data in the electronic paper 300 when the printer 100 cannot perform printing. Therefore, the print data can be printed if the electronic paper 300 is brought to another printable printer. In this way, the user can have the print data printed promptly without waiting for the printer 100 to come back to the printable condition.

In the first embodiment, which data should be written in the electronic paper 300 is determined based on whether writing print data is permitted for the electronic paper 300 by referring to the ID unique to the electronic paper 300. However, which data should be written may be determined based on other criteria. For example, restrictions may also be imposed on writing the display data, in addition to the print data, for the electronic paper 300.

Further, when the CPU 31 proceeds to S111 due to some unprintable situation of the printer 100 (S103: NO), conditions for writing data may be determined based on whether the unprintable state is caused by hardware factors or software factors. Specifically, if the printer 100 cannot print due to hardware factors (such as running out of papers or lack of any toner), the printer 100 may write both of the print data and the display data in the electronic paper 300 in order to facilitate retry of printing the print data sometime later. If any software problem prevents the printer 100 from performing printing (user authority, time restriction, lack of charged money and the like), the printer 100 may not write data in the electronic paper 300 so as to observe such restrictions for printing.

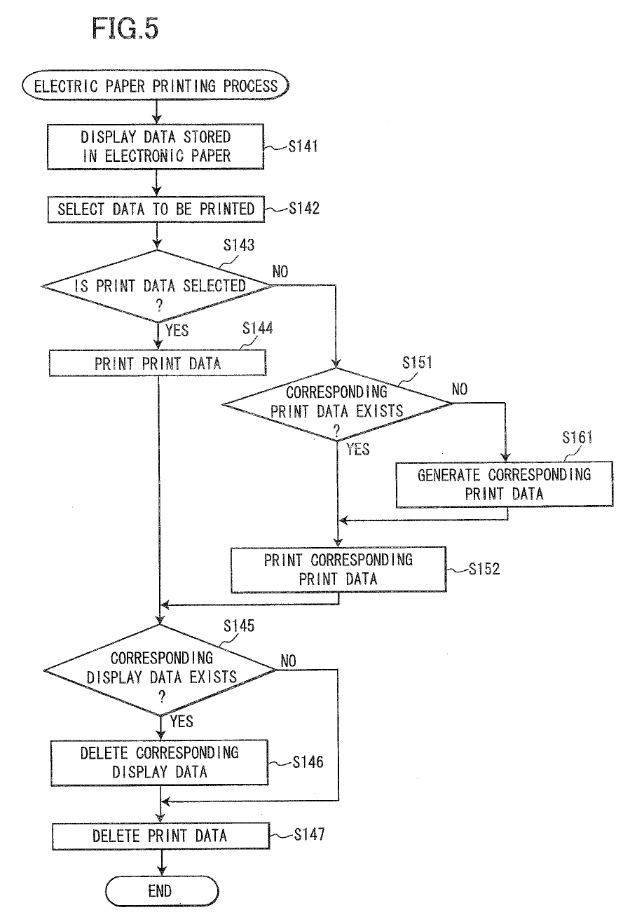

Next, the electronic paper printing process according to the first embodiment will be described with reference to a flowchart of FIG. 5 and FIGS. 6 and 7.

In the electronic paper printing process, the printer 100 prints data stored in the electronic paper 300. This electronic paper printing process is launched when the printer 100 is communicable with the electronic paper 300 and receives a command to print data stored in the electronic paper 300.

Upon starting the electronic paper printing process, in S141 the CPU 31 accesses the electronic paper 300, obtains information on data stored in the electronic paper 300 and displays the obtained information on the operation panel 40.

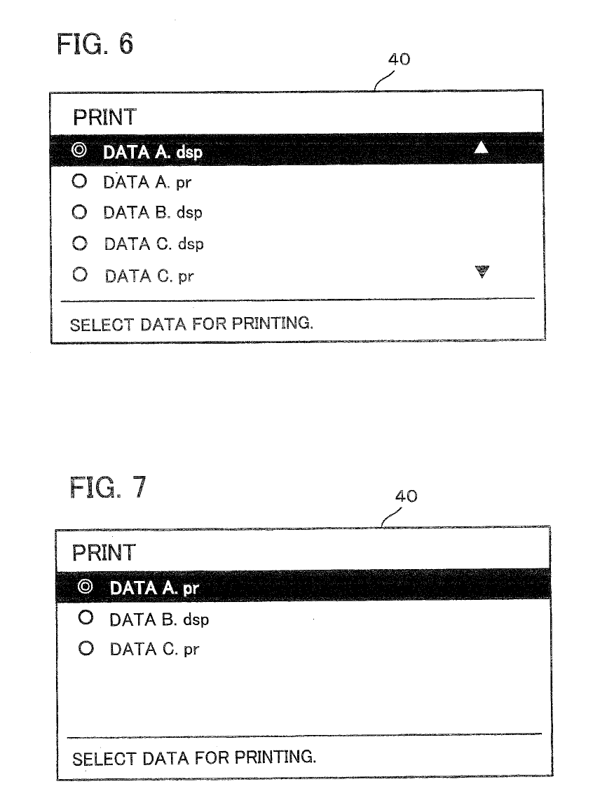

For example, suppose that the electronic paper 300 has stored display data and print data as shown in FIG. 4. In this case, a list of data stored in the electronic paper 300 will be displayed on the operation panel 40 of the printer 100, as shown in FIG. 6. On this screen, the user can select which data to print.

On the display screen shown in FIG. 6, the display data and the print data corresponding to the display data are being displayed simultaneously. Conceivably, the list shown on the screen would become more complicated as there exist more display data and print data associated with the display data. Therefore, as an alternative, only print data may be displayed as shown in FIG. 7 for the sake of simplified display. Or, only display data may be listed on the display screen instead of print data. As a further variation, either one of the data may be grayed out to indicate that the grayed-out data is not available for selection.

In S142 the CPU 31 accepts data selected by the user on the operation panel 40. The user selects data from the list of data shown on the operation panel 40 (see FIG. 6, for example). Then in S143 the CPU 31 determines whether the selected data is print data. If the print data is selected (S143: YES), the CPU 31 controls the image forming unit 10 to print the selected print data in S144.

On the other hand, if the selected data is not print data but display data (S143: NO), in S151 the CPU 31 determines whether there exists print data corresponding to the selected display data in the electronic paper 300. If corresponding print data is available (S151: YES), in S152 the CPU 31 controls the image forming unit 10 to print the print data. However, if there exists no print data corresponding to the display data (S151: NO), in S161 the CPU 31 generates print data that corresponds to the selected display data from the display data, and then prints the generated print data in S152.

In this way, when display data is selected by the user but print data corresponding to the selected display data is stored in the electronic paper 300, the printer 100 automatically prints the print data, instead of the display data. With this configuration, the user can automatically obtain printed materials resulting from the print data at the time of performing printing, without positively distinguishing between print data and display data. Only when corresponding print data is not available, print data is generated from display data as is conventionally done.

After the print data is printed in S144 or in S152, the CPU 31 then determines in S145 whether the print data has corresponding display data. If there is display data corresponding to the print data (S145: YES), in S146 the CPU 31 deletes the display data from the electronic paper 300. Namely, the fact that print data has already been printed means that the user is already provided with sheets on which the necessary data is recorded. Therefore, there remains a low possibility that the same data needs to be displayed again on the electronic paper 300. Automatically deleting the display data from the electronic paper 300 in this way can contribute to deletion of data that is no longer necessary, facilitating writing other data in the electronic paper 300.

When the display data is deleted in S146 or when no corresponding display data exists (S145: NO), in S147 the CPU 31 deletes the print data that has already been printed in S144 or in S152 and ends the current electronic paper printing process. Incidentally, deletion of the display data and/or the print data may not be executed automatically but the user may be prompted to select deletion of these data as an option.

As above described, in the data processing system 500 according to the first embodiment, when the printer 100 receives a print job to instruct writing in the electronic paper 300, the printer 100 writes display data and print data corresponding to the display data in the electronic paper 300. Therefore, the printer 100 can use the print data when printing data stored in the electronic paper 300. With this configuration, even at the time of printing the data stored in the electronic paper 300 (display device), print data can be used for printing, thereby enabling the user to obtain printed materials resulting from data suitable for printing.

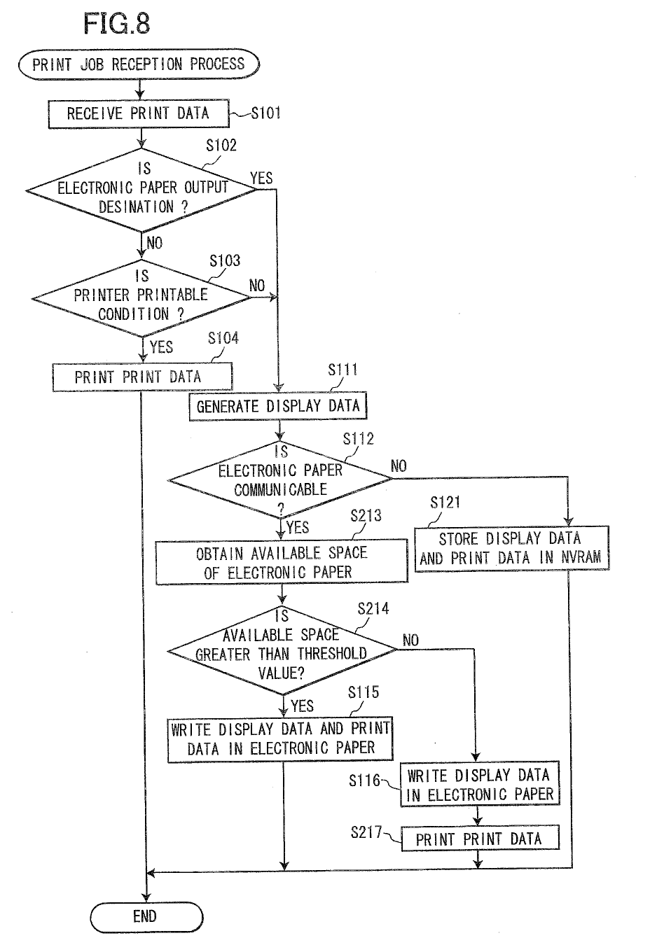

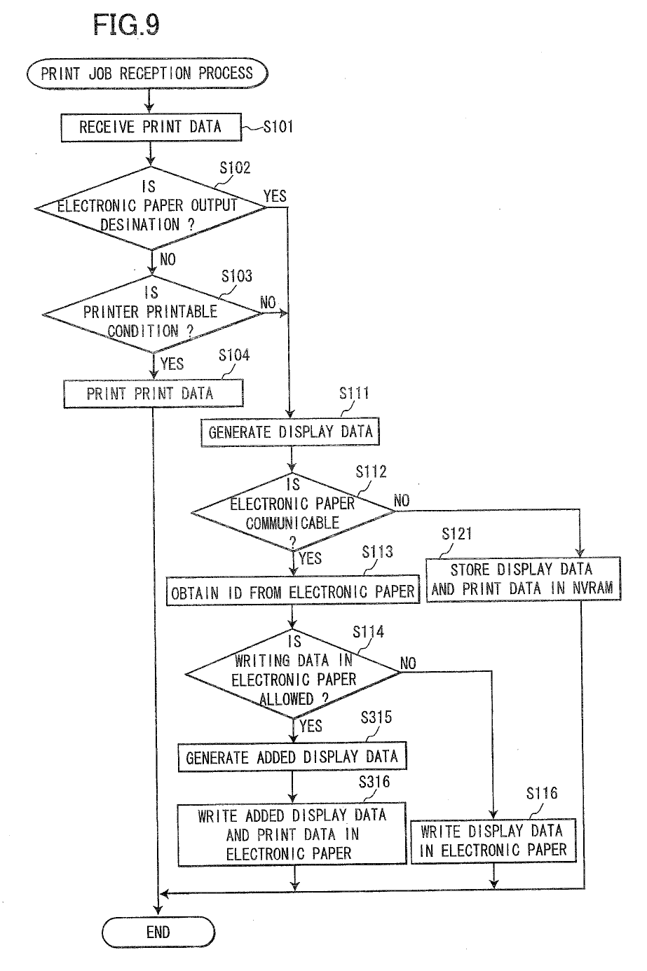

Next, a print job reception process according to a second embodiment will be described with reference to a flowchart of FIG. 8. In FIG. 8, procedures identical to those of the first embodiment will be designated with the same reference numerals as those shown in FIG. 3.

In the print job reception process according to the second embodiment, data to be written in the electronic paper 300 is determined based on amounts of space available in the internal memory 71 of the electronic paper 300.

More specifically, in the second embodiment, when the electronic paper 300 is designated as the output destination of data and the printer 100 is communicable with the electronic paper 300, the CPU 31 performs procedures different from those in the first embodiment. Namely, when the printer 100 is communicable with the electronic paper 300 (S112: YES), in S213 the CPU 31 accesses the electronic paper 300 and obtains how much memory is available in the internal memory 71.

In S214 the CPU 31 then determines whether the amount of memory obtained in S213 is greater than or equal to a threshold value. This threshold value is prestored in the printer 100 as a minimum amount of space required for storing data.

The threshold value may be set to a sum of sizes of the data (print data and display data) that will be actually written.

If the amount of available space is greater than or equal to the threshold value, i.e., there is sufficient space available in the internal memory 71 (S214: YES), in S115 the CPU 31 writes both the print data and the display data in the internal memory 71.

On the other hand, if the amount of available space is smaller than the threshold value (S214: NO), in S116 the CPU 31 only writes the display data in the electronic paper 300. If both of the display data and the print data are to be written in the electronic paper 300 that has insufficient spare space, there is a high possibility that writing both data in the electronic paper 300 is likely to end up with a failure. Therefore, in the second embodiment, only the display data is written in the electronic paper 300, thereby lowering the possibility of writing being interrupted.

Then in S217 the CPU 31 controls the image forming unit 10 to print the print data corresponding to the display data written in S116. With this configuration, printed material based on the data suitable for printing (print data) can be obtained at least for the display data written in the electronic paper 300. When the printer 100 is not in the printable state at this time, the CPU 31 skips the process of S217. Upon completion of printing, the CPU 31 ends the current print job reception process.

As a variation, when enough memory is not available in the electronic paper 300, either one of the print data and the display data may be written in the electronic paper 300. That is, only the print data may be written in the electronic paper 300 instead of the display data. Alternatively, although the display data is automatically determined as the data written in the electronic paper 300 in the second embodiment, a user may instead be prompted to select which data should be written in the electronic paper 300.

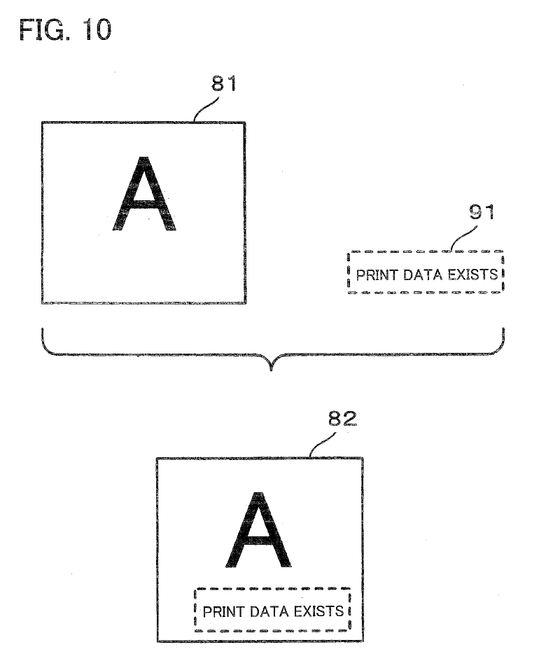

Next, a print job reception process according to a third embodiment will be described with reference to a flowchart of FIG. 9 and FIG. 10. In FIG. 9, procedures identical to those of the first embodiment will be designated with the same reference numerals as those shown in FIG. 3.

In the print job reception process according to the third embodiment, additional information is incorporated in the display data when the display data is written in the electronic paper 300. Specifically, in the third embodiment, when the electronic paper 300 is designated as the output destination of data and writing the print data in the electronic paper 300 is allowed, the CPU 31 performs procedures different from those in the first embodiment. That is, when writing the print data in the electronic paper 300 is permitted (S114: YES), in S315 the CPU 31 generates display data to which additional information is attached (to be referred to as “added display data”). The additional information indicates that print data corresponding to the display data is stored in the electronic paper 300. The added display data is generated based on the display data generated in S111 and the additional information is incorporated in the display data, for example, as shown in FIG. 10.

In S316 the CPU 31 writes the added display data in the electronic paper 300 together with the print data. In this way, the electronic paper 300 displays an image (corresponding to the display data) to which an additional image (corresponding to the additional information) is attached.

Specifically, referring to FIG. 10, in S315 the CPU 31 prepares display data 81 and an additional image 91. The CPU 31 then incorporates the additional image 91 into the display data 81 and generates added display data 82. In S316 the CPU 31 writes this added display data 82 in the electronic paper 300 together with the print data. By combining the additional image 91 with the display data 81 in this way, the user can visually confirm that print data corresponding to the display data 81 has been stored in the electronic paper 300 when the added display data 82 is being displayed.

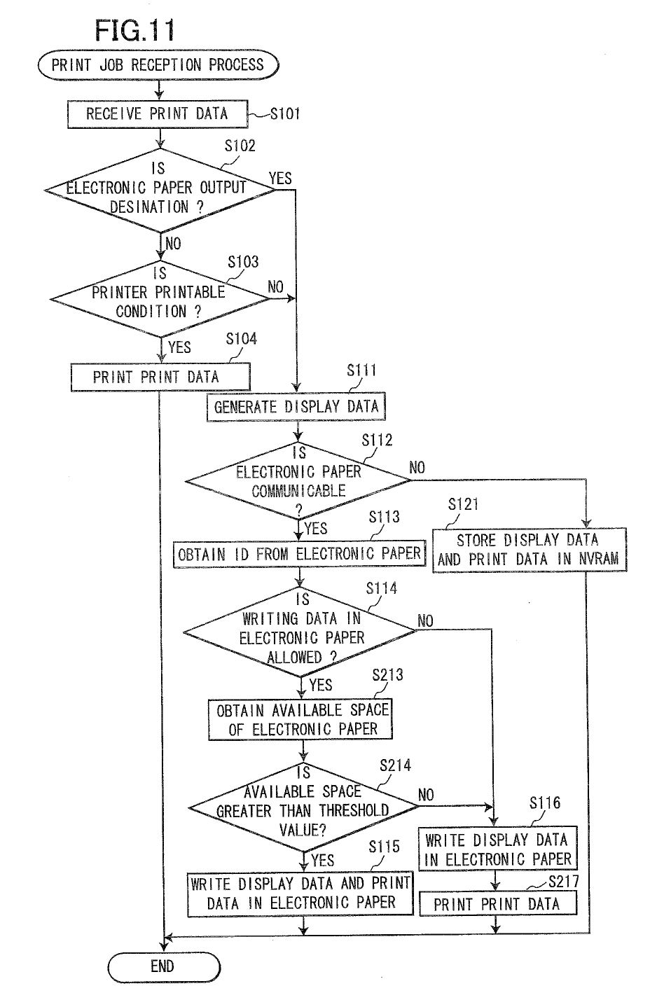

A print job reception process according to a fourth embodiment will be described with reference to FIG. 11. In the fourth embodiment, the first and second embodiments are jointly executed as a single print job reception process. That is, the display data and the print data are both written in the electronic paper 300 if the electronic paper 300 for which writing the print data is allowed has a space larger than the threshold value.

More specifically, as shown in FIG. 11, when the electronic paper 300 is designated as the output destination of data (S102: YES) and the printer 100 is determined to be communicable with the electronic paper 300 (S112: YES), the CPU 31 accesses the electronic paper 300 to acquire the peculiar ID no. in S113. Then the CPU 31 determines whether the electronic paper 300 is allowed for the print data to be written therein in S114. If the CPU 31 determines that writing the print data in the electronic paper 300 is allowed (S114: YES), in S213 the CPU 31 then obtains how much memory is available in the internal memory 71 of the electronic paper 300. In S214 the CPU 31 determines whether sufficient memory is left in the electronic paper 300. When sufficient data is left in the electronic paper 300 (S214: YES), both the print data and the display data are written in the electronic paper 300 in S115. If the amount of space left in the electronic paper 300 is smaller than the threshold value (S214: NO), in S116 only the display data is written in the electronic paper 300.

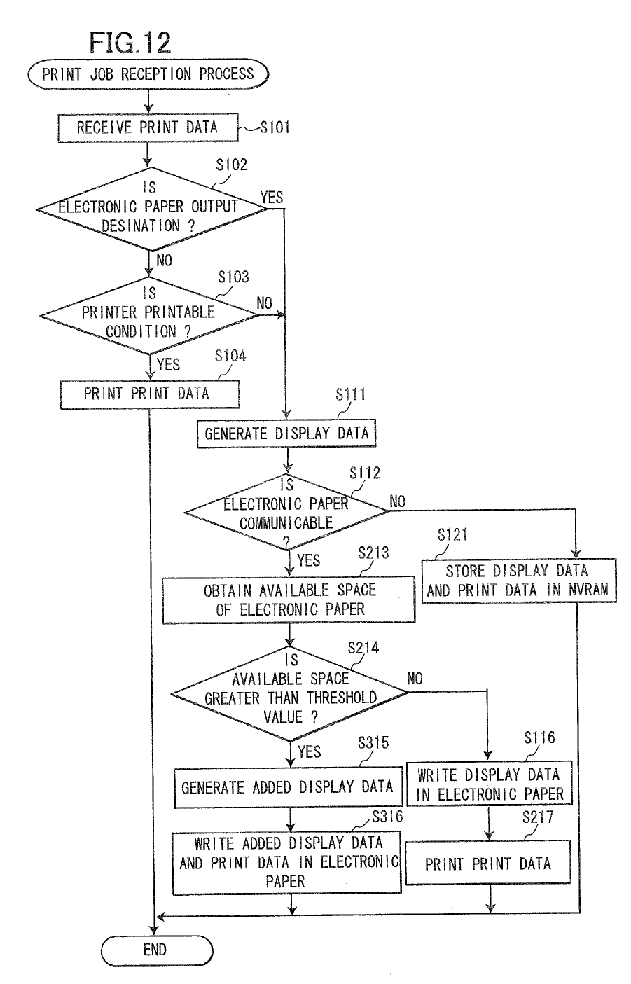

A print job reception process according to a fifth embodiment is shown in FIG. 12. In the fifth embodiment, the second and third embodiments are jointly executed. That is, as shown in FIG. 12, when the electronic paper 300 is designated as the output destination of data (S102: YES) and the printer 100 is determined to be communicable with the electronic paper 300 (S112: YES), in S213 the CPU 31 obtains how much memory is available in the internal memory 71 of the electronic paper 300. Upon determining in S214 that there is enough space left in the electronic paper 300, in S315 the CPU 31 generates the added display data. Subsequently in S316 the CPU 31 writes the added display data and the print data in the electronic paper 300.

While the invention has been described in detail with reference to the embodiments thereof, it would be apparent to those skilled in the art that various changes and modifications may be made therein without departing from the spirit of the invention.

For example, the present invention may be applicable to a printing device other than a printer, such as a multifunction device, a copier and other device with a printing function. Similarly, the information processing device that outputs the print job may not be limited to a personal computer. A PDA and a server may also be employed.

Further the electronic paper 300 is employed as a display device in the first to fifth embodiments, but the present invention is not limited to this configuration. Any device provided with a display function and capable of storing data that can be outputted from a printing device may also be employed. For example, a USB memory having a viewer function can be used. In this case, this USB memory is connected to the printer 100 via the USB interface 37, thereby enabling the printer 100 to perform direct printing of data stored in the USB memory. Further, a digital photo frame may also be employed as a display device.

Further, the CPU 31 of the printer 100 determines whether to write data in the electronic paper 300 based on whether the print job contains information indicating that the electronic paper 300 is the destination of output in the first through fifth embodiments. However, where to write data may be determined individually by respective commands received from the PC 200. Specifically, each command may indicate, independently, that data should be written in the electronic paper 300 or data should be printed on sheets. In this case, the CPU 31 may determine whether the data should be written in the electronic paper 300 or be printed on sheets in accordance with the instructions contained in each command.

Further, in the above-described embodiments, the PC 200 transmits, to the printer 100, data in a format immediately before being printed (PDL data, for example) as the print data. The print data is then written in the electronic paper 300.

However, the print data may be in another format, such as image data stored in the PC 200 (for example, JPEG data) and document data (text data, for example). Such print data may be directly transmitted and written in the electronic paper 300 without any modification. In this case, when printing the print data stored in the electronic paper 300, the printer 100 converts the print data (JPEG data or text data) into PDL data, for example.

Further, in order to demonstrate correspondence between display data and print data, two correlating data (display data and print data) are given filenames identical to each other but provided with extensions different from each other. However, as a variation, correlation between display data and print data may be stored in a separate database.

Further, in the data processing system 500 of the first to fifth embodiments, the PC 200 transmits the print data to the printer 100, and the printer 100 generates the display data corresponding to the print data and writes both data in the electronic paper 300. However, instead, the printer 100 may generate both the print data and the display data based on the print data, and may write both data in the electronic paper 300.

Alternatively, the printer driver 61 embedded in the PC 200 may write data in the electronic paper 300. In this case, when a print job is input from the PC 200 indicating that the electronic paper 300 should be the output destination, the printer driver 61 generates the print data and the display data corresponding to the print data. Then the printer driver 61 transmits both data to the printer 100, and writes both data in the electronic paper 300 via the printer 100. As a further alternative, when the PC 200 and the electronic paper 300 are in direct communication with each other, the PC 200 may write both data in the electronic paper 300 directly without interposing the printer 100. In any case, both of the display data and print data are written in the electronic paper 300, enabling the user to carry out printing based on the print data.

What is claimed is:

1. A data processing system comprising:
a display device provided with a display function;
a printing device provided with a printing function;
a generation unit configured to generate display data from print data, the display data being displayable on the display device, and the print data being printable by the printing device; and,
a writing unit configured to write the display data and the print data in the display device, the printing device printing the print data stored in the display device.

2. The data processing system according to claim 1, wherein the writing unit writes the display data and the print data in the display device when a predetermined condition is met.

3. The data processing system according to claim 2, further comprising:
an acquisition unit configured to acquire a specific information as the predetermined condition, the specific information indicating whether the display device is permitted to write the print data therein, and,
a restriction unit configured to restrict the writing unit from writing the print data in the display device based on the specific information.

4. The data processing system according to claim 3, wherein the writing unit writes the display data and the print data in the display device when the specific information indicates that writing the print data in the display device is permitted.

5. The data processing system according to claim 3, wherein the restriction unit restricts the writing unit from writing the print data in the display device when the specific information indicates that writing the print data in the display device is not permitted.

6. The date processing system according to claim 3, further comprising:
a determination unit configured to determine whether the display device has an amount of space greater or equal to a predetermined threshold value, the amount of space being the predetermined condition;
wherein the writing unit writes the display data and the print data in the display device when the specific information indicates that writing the print data in the display device is permitted, and when the determination unit determines that the display device has the amount of space greater than or equal to the threshold value.

7. The data processing system according to claim 3, further comprising an integration unit configured to integrate additional information with the display data to generate integrated display data when the specific information indicates that writing the print data in the display device is permitted, the additional information indicating that the print data corresponding to the display data is stored in the display device;
wherein the writing unit writes the integrated display data and the print data in the display device.

8. The data processing system according to claim 2, further comprising:
a determination unit configured to determine whether the display device has an amount of space greater or equal to a predetermined threshold value, the amount of space being the predetermined condition;
wherein the writing unit writes the display data and the print data in the display device when the determination unit determines that the display device has the amount of space greater than or equal to the threshold value.

9. The data processing system according to claim 8, wherein the writing unit writes either one of the display data and the print data in the display device when the determination unit determines that the display device has the amount of space smaller than the threshold value.

10. The data processing system according to claim 9, wherein the writing unit writes the display data in the display device and the printing device prints the print data when the determination unit determines that the amount of space of the display device is smaller than the threshold value.

11. The data processing system according to claim 8, further comprising an integration unit configured to integrate additional information with the display data to generate integrated display data when the determination unit determines that the display device has the amount of space greater than or equal to the threshold value, the additional information indicating that the print data corresponding to the display data is stored in the display device;
wherein the writing unit writes the integrated display data and the print data in the display device.

12. The data processing system according to claim 1, further comprising a detection unit configured to detect whether the printing device is in a state that printing can be performed;
wherein the writing unit writes the display data and the print data in the display device when the detection unit detects that the printing device is not in the printable state.

13. The data processing system according to claim 1, further comprising a storage unit that stores the display data and the print data when the writing unit fails to write the display data and the print data in the display device.

14. The data processing system according to claim 1, further comprising:
an instruction unit configured to instruct any one of the display data and the print data stored in the display device to be printed; and
a replacing unit configured to replace the display data with the print data when the instruction unit instructs the display data to be printed.

15. The data processing system according to claim 14, wherein the instruction unit enables either one of the display data and the print data to be selected as data to be printed when both of the display data and the print data corresponding to the display data are stored in the display device.

16. The data processing system according to claim 14, further comprising a deletion unit configured to delete the display data stored in the display device when the print data corresponding to the display data is printed by the printing device.

17. The data processing system according to claim 1, wherein the generation unit generates the display data based on display performance of the display device.

18. A non-transitory storage medium storing a set of program instructions executable on a computer, the set of program instructions comprising:
generating display data from print data, the display data being displayable on a display device connectable to the computer, the print data and the display data being in association with each other; and
writing the display data and the print data in the display device.

19. A printing device comprising:
a printing unit configured to print print data;
a print data acquisition unit configured to acquire the print data;
a display data generation unit configured to generate display data from the print data, the display data being displayable on a display device connectable to the printing device; and
a writing unit configured to write the display data and the print data in the display device.

20. A printing device comprising:
a printing unit configured to print print data;
a communication unit configured to allow data communications with a display device capable of storing the print data and display data displayable on the display device, the print data and the display data being in association with each other; and
an instruction unit configured to instruct any one of the print data and the display data stored in the display device to be printed; and
a replacing unit configured to replace the display data with the print data associated with the display data when the instruction unit instructs the display data to be printed.

21. The printing device according to claim 20, wherein the instruction units enables either one of the display data and the print data to be selected as data to be printed when both of the display data and the print data associated with the display data are stored in the display device.

22. The printing device according to claim 20, further comprising a deletion unit configured to delete the display data stored in the display device, the deletion unit deleting the display data when the printing unit has printed the print data associated with the display data.
